(19) United States
(12) Patent Application Publication
(10) Pub. No.: US 2007/0151398 A1
(43) Pub. Date: Jul. 5, 2007

(54) Mechanical organ type accelarator pedal

(75) Inventors: Kyung Min Kim, Busan (KR); Kwang Hyuck Lee, Busan (KR); Yong Hwan Mo, Ulsan (KR)

Correspondence Address: HAMRE, SCHUMANN, MUELLER & LARSON, P.C., P.O. BOX 2902, MINNEAPOLIS, MN, 55402-0902, US

(73) Assignee: DONGHEE INDUSTRIAL CO., LTD., Ulsan Metropolitan City (KR)

(21) Appl. No.: 11/637,583

(22) Filed: Dec. 12, 2006

(30) Foreign Application Priority Data
Dec. 13, 2005 (KR) 10-2005-0122741

(51) Int. Cl. G05G 1/14

(52) U.S. Cl. 74/513

(57) ABSTRACT

The present invention relates to a mechanical organ type accelerator pedal which includes: a housing that is fixedly disposed to a floor panel under a driver's seat; a foot plate whose one end is coupled hingedly with the housing and the other end is disposed to be rotated in a vertical direction of the housing by driver's stepping force on the pedal; a pedal arm that is coupled with one end of a connecting cable connected to an acceleration cable and disposed to be rotatable inside the housing in conjunction with the operation of the foot plate; a carrier that penetrates the housing to connect the foot plate and the pedal arm; an elastic means that is disposed to be supported by the housing and the carrier at both ends to apply restoring force to the carrier; and a cover that is coupled with the housing to cover an opening at one side of the housing and has a center protrusion at one side, the center protrusion being inserted in the center part of the carrier and serving as a rotating fulcrum. The mechanical organ type accelerator pedal improves an operation feeling and reduces driver's fatigue, and reduces fuel efficiency by improving fuel consumption ratio, and improves stability via the compression spring and the carrier which restricts the maximum angle of the reverse rotation of the foot plate.

### BACKGROUND OF THE INVENTION

1. Field of the Invention

The present invention relates to a mechanical organ type accelerator pedal, and particularly, to a mechanical organ type accelerator pedal to improve an operation feeling and reduce driver's fatigue while achieving stability and economic feasibility.

2. Description of the Related Art

Generally, an accelerator pedal of a vehicle is a device which regulates an inhalation quantity of fuel-air mixture in a gasoline engine, and regulates an injection quantity of fuel in a diesel engine, to control number of revolution of an engine. The accelerator is classified into a pendant type which is hung on a dashboard and an organ type which is disposed on a floor panel depending on a mounting structure.

Recently, a mechanical accelerator pedal is widely used to control the quantity of combustion by opening/closing a throttle valve in a carburetor through an acceleration cable.

However, a conventional mechanical accelerator pedal gives a driver a rough operation feeling, accordingly, a problem is found in that the rough operation feeling increases driver's fatigue.

In addition, since the opening/closing of the throttle valve cannot be operated with accuracy, unexpected waste of fuel is inevitably generated, thus making worse fuel efficiency as well as stability.

### SUMMARY OF THE INVENTION

The present invention has been devised to solve the above problem. An object of the present invention is to provide a mechanical organ type accelerator pedal in which an organ type pedal is employed to serve as a mechanical accelerator pedal while maintaining the function of the mechanical accelerator pedal which controls an opening/closing operation of a throttle valve in a carburetor through an acceleration cable to improve an operation feeling and thus reduce driver's fatigue, and to enable an accurate operation of the throttle valve to achieve stability and economic feasibility, and to improve the interior look to upgrade a vehicle.

In order to accomplish the above object, the present invention provides a mechanical organ type accelerator pedal which includes: a housing that is fixedly disposed to a floor panel under a driver's seat; a foot plate whose one end is coupled hingedly with the housing and the other end is disposed to be rotated in a vertical direction of the housing by driver's stepping force on the pedal; a pedal arm that is coupled with one end of a connecting cable connected to an acceleration cable and disposed to be rotatable inside the housing in conjunction with the operation of the foot plate; a carrier that penetrates the housing to connect the foot plate and the pedal arm an elastic means that is disposed to be supported by the housing and the carrier at both ends to apply restoring force to the carrier; and a cover that is coupled with the housing to cover an opening at one side of the housing and has a center protrusion at one side, the center protrusion being inserted in the center part of the carrier and serving as a rotating fulcrum.

### BRIEF DESCRIPTION OF THE DRAWINGS

The above and other features and advantages of the present invention will become more apparent by describing preferred embodiments thereof in detail with reference to the attached drawings in which:

FIG. 1 is a perspective view illustrating a mechanical organ type accelerator pedal according to the present invention;

FIG. 2 is an exploded perspective view of the mechanical organ type accelerator pedal according to the present invention;

FIG. 3 is a right side view illustrating an assembly of the pedal of FIG. 2;

FIG. 4 is an exploded perspective view illustrating a pedal arm and a carrier in the pedal of FIG. 2;

FIG. 5 is a partial enlarged view illustrating an elastic means disposed in the device of FIG. 2; and

FIG. 6 is a partial cross-sectional view taken along the line I-I of FIG. 3, illustrating the coupled condition of the pedal arm.

### DESCRIPTION OF THE PREFERRED EMBODIMENTS

Hereinafter, embodiments of the invention will be described with reference to the accompanying drawings.

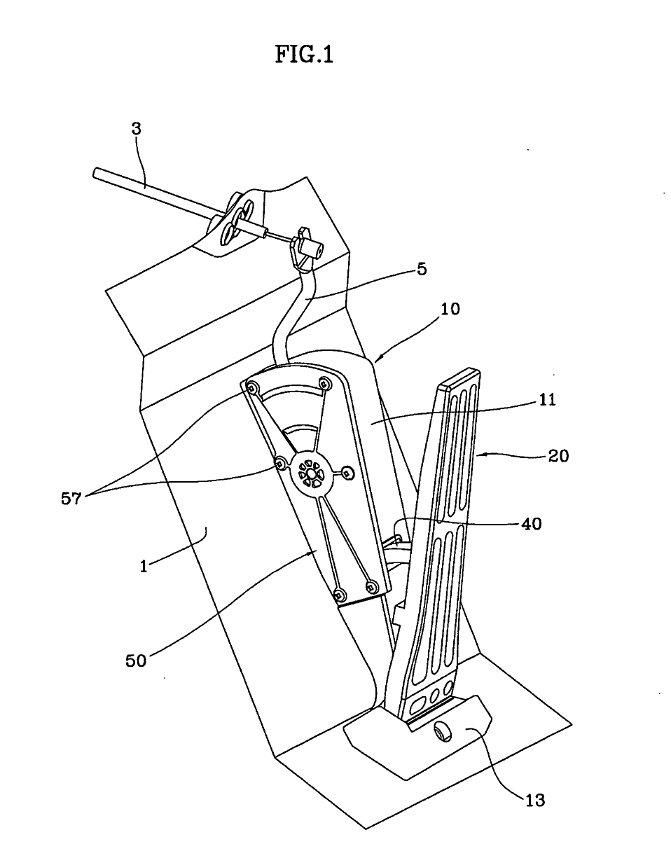

FIG. 1 is a perspective view illustrating a mechanical organ type accelerator pedal according to the present invention.

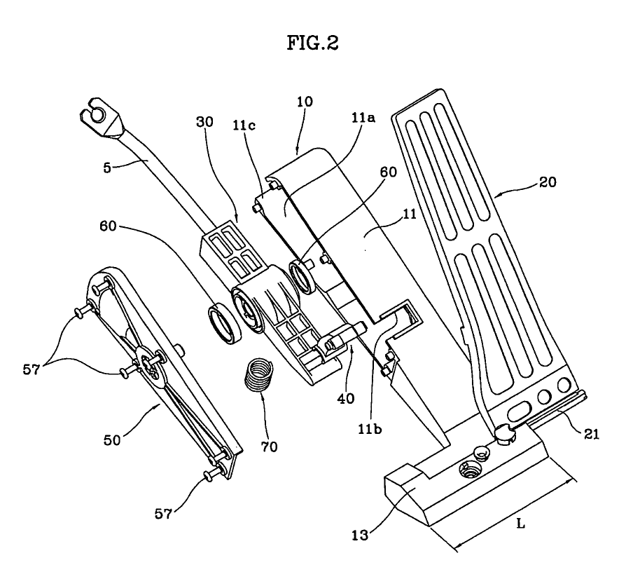

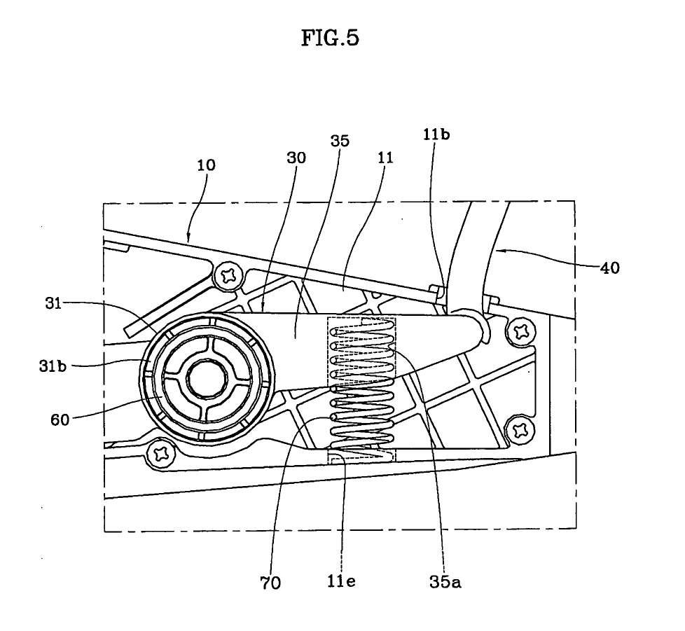

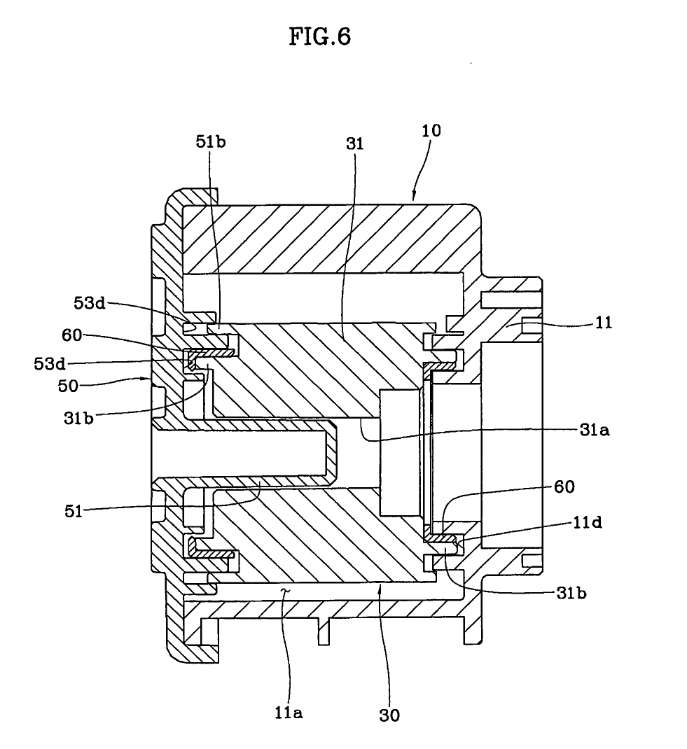

A mechanical organ type accelerator pedal according to the present invention, as shown in FIGS. 1 to 6, is composed of a housing 10 that is fixedly disposed to a floor panel 1 under a driver's seat, a foot plate 20 whose one end is coupled hingedly with the housing 10 and the other end is disposed to be rotated in a vertical direction of the housing 10 by driver's stepping force on the pedal, a pedal arm 30 that is coupled with one end of a connecting cable 5 connected to an acceleration cable 3 and disposed to be rotatable inside the housing 10 in conjunction with the operation of the foot plate 20, a carrier 40 that penetrates the housing 10 to connect the foot plate 20 and the pedal arm 30, an elastic means that is disposed to be supported by the housing 10 and the carrier 40 at both ends to apply restoring force to the carrier 40, and a cover 50 that is coupled with the housing 10 to cover an opening at one side of the housing 10 and a center protrusion 51 is formed at one side of the cover 50 so as to be inserted in the center part of the carrier 40 and to serve as a rotating fulcrum.

Here, in the mechanical organ type accelerator pedal according to the invention, when the connecting cable 5 pulls the acceleration cable 3 in accordance with the operation of the pedal arm 30, a throttle valve is opened to control the quantity of combustion.

In the meantime, the housing 10 is composed of a body 11 and a plate coupling part 13.

The body 11 has an accommodation space 11a therein to accommodate the pedal arm 30 and the elastic means. An upper side of the body facing the foot plate 20 in the accommodation space 11a has a carrier hole 11b through which the carrier 40 passes, and a front side of the body facing the acceleration cable 3 in the accommodation space 11a has a cable hole 11c through which the connecting cable 5 passes.

In addition, the cover 50 is coupled with the body 11 at one side by using a plurality of screws 57 to cover the accommodation space 11a.

The plate coupling part 13 is formed to extend from the body 11, and a coupling hole 13a that is opened in one direction is formed in the width direction L.

One end of the foot plate 20 is inserted in the coupling hole 13a. Particularly, a hinge film 21 that is integrated to one end of the foot plate 20 is inserted in the coupling hole 13a to serve as a hinge.

The pedal arm 30 is composed of the cylindrical part 31 which is formed by forming a flange 31b in a circumferential direction around a protrusion hole 31a to protrude in a lateral direction, a protrusion hole 31a being located between the carrier hole 11b and the cable hole 11c in the accommodation space 11a, and is formed through the center portion at both sides of a cylinder part 31 such that the center protrusion 51 of the cover 50 is inserted in the protrusion hole, a front arm 33 which is formed to extend toward the cable hole 11c from the outer surface of the cylindrical part 31 and coupled with the connecting cable 5 at a leading end of the front arm, and a rear arm 35 which is formed to extend toward the carrier hole 11b from the outer surface of the cylindrical part 31 and coupled with the lower end of the carrier 40 at a leading end of the rear arm.

As the center protrusion 51 of the cover 50 is inserted in the protrusion hole 31a of the cylindrical part 31, the pedal arm 30 is able to seesaw inside the accommodation space 11a when an external force is applied.

In the meantime, the flange 31b formed at both side surfaces of the cylindrical part 31 is inserted in flange holes 11d and 53d formed in the body 11 of the housing 10 and the cover 50, respectively, to be coupled therewith.

Here, a bushing 60 is inserted between the flange 31b and the flange holes 11d and 53d, and the bushing 60 prevents abrasion arising from friction.

The carrier 40 is disposed to penetrate the carrier hole 11b, and the upper end of the carrier is coupled with the foot plate 20 and the lower end of the carrier is coupled with the rear arm 35 of the pedal arm 30.

Here, the lower end of the carrier 40 is formed in a fork shape to be fitted with a rod 35a which is provided at the end of the rear arm 35.

In addition, the carrier 40 serves to prevent the foot plate 20 from being rotated by its weight and thus overlapped on the housing 10.

A compression spring 70 is used as the elastic means, the upper end of the compression spring 70 is inserted in a upper hole 35a formed at the lower side of the rear arm 35, and the lower end of the compression spring is inserted in a lower hole 11e formed at the lower side of the body 11 in the accommodation space 11a.

Although the number of the compression spring 70 is one in the present invention, it is not limited thereto; for example, a double structure in which two springs having different diameters are overlapped with each other may be provided if necessary.

Hereinafter, operation and effect according to the embodiment of the invention will be described.

When a driver steps on the foot plate 20, the foot plate 20 rotates toward the housing 10 by the hinge film 21, and thus the carrier 40 descends.

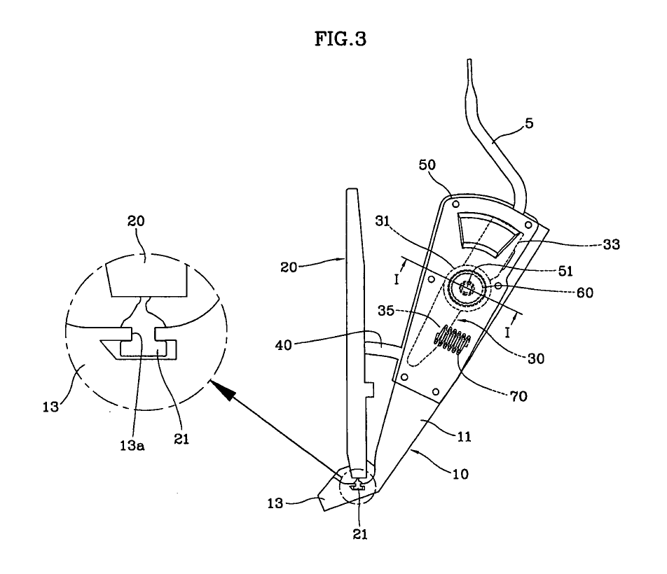

The descent of the carrier 40 causes a rotation arm 30 to rotate clockwise with respect to the center protrusion 51, from the condition shown in FIG. 3, and at this moment, the compression spring 70 is deformed such that the entire length is shortened.

As the rotation arm 30 rotates, the connecting cable 5 is pulled, and accordingly the acceleration cable 3 is pulled in conjunction with the connecting cable so as to open/close the throttle valve, thereby controlling the quantity of combustion.

When the foot of the driver is removed from the foot plate 20, the rotation arm 30 is rotated counterclockwise by restoring force of the compression spring 70, and the carrier 40 ascends, and the foot plate 20 is rotated away from the housing 10 so as to return to an initial position.

At this moment, the connecting cable 5 and the acceleration cable 3 that are pulled toward the housing 10 return to an initial position to prepare for the next operation.

In addition, when the foot plate 20 is reversely rotated, the maximum rotation angle is restricted by the carrier 40; therefore, the foot plate 20 returns to the initial position at all times to prepare for the next operation.

Therefore, in the mechanical organ type accelerator pedal according to the invention, an organ type pedal is employed to serve as a mechanical accelerator pedal while maintaining the function of the mechanical accelerator pedal which controls an opening/closing operation of a throttle valve in a carburetor through an acceleration cable to improve an operation feeling and thus reduce driver's fatigue.

In addition, an accurate operation of the throttle valve is enabled by the improved operation feeling, and unexpected waste of fuel is reduced to achieve economic feasibility.

Further, the mechanical organ type accelerator pedal according to the invention has an improved stability.

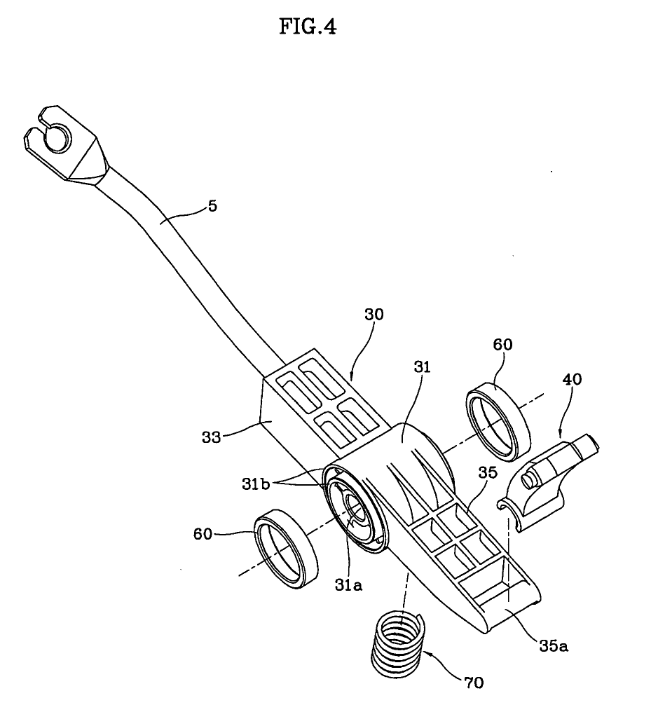

That is, the foot plate 20 which is rotated toward the housing 10 by driver's stepping force on the pedal rotates reversely away from the housing 10 when the foot of the driver is removed from the pedal so as to return to the initial position. At this time, if a driver's shoe or cloth is caught on the foot plate 20, the foot plate 20 deviates from a normal condition shown in FIG. 4, and is pulled back completely.

The above-described case may occur when a vehicle travels on a steep incline.

However, according to the invention, since the carrier 40 restricts the maximum rotation angle of the reverse rotation of the foot plate 20, the foot plate 20 is prevented from deviating from the normal condition and being pulled back completely as described above, thereby improving stability of the vehicle.

On the contrary, when the vehicle travels on a steep downhill road, the foot plate 20 is forced to rotate toward the housing 10 by its weight, but the carrier 40 which has received force from the compression spring 70 through the pedal arm 30 restricts the rotation of the foot plate 20, thus improving stability of operation.

As described above, the mechanical organ type accelerator pedal according to the present invention improves an operation feeling and reduces driver's fatigue, and reduces fuel efficiency by improving fuel consumption ratio, and improves stability via the compression spring and the carrier which restricts the maximum angle of the reverse rotation of the foot plate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mechanical organ type accelerator pedal, comprising:
a housing that is fixedly disposed to a floor panel under a driver's seat;
a foot plate whose one end is coupled hingedly with the housing 10 and the other end is disposed to be rotated in a vertical direction of the housing by driver's stepping force on the pedal;
a pedal arm that is coupled with one end of a connecting cable connected to an acceleration cable and disposed to be rotatable inside the housing in conjunction with the operation of the foot plate;
a carrier that penetrates the housing to connect the foot plate and the pedal arm;
an elastic means that is disposed to be supported by the housing and the carrier at both ends to apply restoring force to the carrier; and
a cover that is coupled with the housing to cover an opening at one side of the housing and has a center protrusion at one side, the center protrusion being inserted in the center part of the carrier and serving as a rotating fulcrum.

2. The mechanical organ type accelerator pedal as set forth in claim 1, wherein the housing includes:
a body having an accommodation space therein to accommodate the pedal arm and the elastic means, in which an upper side of the body facing the foot plate in the accommodation space has a carrier hole through which the carrier passes, and a front side of the body facing the acceleration cable in the accommodation space Ida has a cable hole through which the connecting cable passes, and the cover being coupled with the body at one side to cover the accommodation space; and
a plate coupling part formed to extend from the body, in which a coupling hole that is opened in one direction is formed thereon in the width direction and one end of the foot plate is inserted in the coupling hole to be coupled hingedly.

3. The mechanical organ type accelerator pedal as set forth in claim 2, wherein a hinge film that is integrated to one end of the foot plate is inserted in the coupling hole to serve as a hinge.

4. The mechanical organ type accelerator pedal as set forth in claim 2, wherein the pedal arm includes:
a cylindrical part that is formed by forming a flange in a circumferential direction around a protrusion hole to protrude in a lateral direction, the protrusion hole being located between the carrier hole and the cable hole in the accommodation space and formed through the center portion at both sides of the cylinder part such that the center protrusion of the cover is inserted in the protrusion hole;
a front arm that is formed to extend toward the cable hole from the outer surface of the cylindrical part and coupled with the connecting cable at a leading end of the front arm; and
a rear arm that is formed to extend toward the carrier hole from the outer surface of the cylindrical part and coupled with the lower end of the carrier at a leading end of the rear arm.

5. The mechanical organ type accelerator pedal as set forth in claim 4, wherein the flange formed at both side surfaces of the cylindrical part is inserted in flange holes formed in the body of the housing and the cover to be coupled therewith.

6. The mechanical organ type accelerator pedal as set forth in claim 5, wherein a bushing is inserted between the flange and the flange holes.

7. The mechanical organ type accelerator pedal as set forth in claim 4, wherein the elastic means is a compression spring whose upper end is inserted in a upper hole formed at the lower side of the rear arm, and whose lower end is inserted in a lower hole formed at the lower side of the body in the accommodation space.
